(19) United States
(12) Patent Application Publication
(10) Pub. No.: US 2010/0224770 A1
(43) Pub. Date: Sep. 9, 2010

(54) METHOD FOR CONFIGURING AN ION MOBILITY SPECTROMETER SYSTEM

(75) Inventors: Douglas BURNS, Melbourne, FL (US); Marshall Cory, JR., Gainesville, FL (US); Jeffrey Piotrowski, Rockledge, FL (US)

Correspondence Address: NIXON PEABODY, LLP, 401 9TH STREET, NW, SUITE 900, WASHINGTON, DC, 20004-2128, US

(73) Assignee: Ensco, Inc., Falls Church, VA (US)

(21) Appl. No.: 12/487,360

(22) Filed: Jun. 18, 2009

Related U.S. Application Data
(60) Provisional application No. 61/158,147, filed on Mar. 6, 2009.

(51) Int. Cl. G01D 18/00; B01D 59/44; H01J 49/00

(52) U.S. Cl. 250/252.1; 250/282; 250/288

(57) ABSTRACT

This invention relates to a method of configuring an ion mobility spectrometer system, particularly for detecting a target analyte. The method involves using quantum chemical techniques to estimate the Kₒ values of the target analyte, and configure the ion mobility spectrometer system based upon a detection algorithm.

### RELATED APPLICATIONS

This application claims the benefit of U.S. Provisional Patent Application No. 61/158,147, filed on Mar. 6, 2009, which is herein incorporated by reference in its entirety.

### FIELD OF THE INVENTION

This invention relates to a method of configuring an ion mobility spectrometer system, particularly for detecting target analytes.

### BACKGROUND OF THE INVENTION

An ion mobility spectrometer is a known device for detecting and identifying trace chemicals in the air or removed from surfaces. They are widely used for the detection of explosives, chemical warfare agents, and narcotics. Conventional ion mobility spectrometers have three main components: a reaction chamber, a drift tube, and a detector. A sample of a target analyte is introduced into the reaction, or ionization chamber, where it flows though a shuttered grid and into the drift tube. Within the drift tube, the ions are subjected to an applied electric field, driving them through neutral drift molecules, and onto a detector. The ion mobility of the analyte upon its arrival at the detector is compared to the recorded ion mobility of various identified analytes in order to determine the chemical species of the same. It is possible to determine the chemical makeup of the analyte to a high degree of accuracy by this method, due to the differences in drift times (differences in mobility) of the different ions caused by their unique interactions with the neutral drift gases.

Conventional ion mobility spectrometers carry a built-in database of identified analytes and their respective ion mobilities. Some ion mobility spectrometers carry databases that only cover a limited number of identified analytes, and are not readily updatable or extensible. Other ion mobility spectrometers require additional software libraries be purchased in order to detect a full range of new and existing chemical agents.

Various chemical properties (e.g., ion mobility) must be measured in order to introduce new or existing analytes into the ion mobility spectrometer library and configure the device accordingly. To achieve accurate values, this process is typically completed experimentally in three different settings: a controlled bench, a chamber, and in the field, subjected to various environmental variables. This three-step process, however, can be time-consuming and costly.

Accordingly, there is a need in the art for a method of efficiently configuring an ion mobility spectrometer library with identification information of additional new and existing analytes.

### SUMMARY OF THE INVENTION

The invention relates to a method of configuring an ion mobility spectrometer system for detecting a target analyte, by determining potential cluster structures for the analyte and the binding energies that correspond with formation of the potential cluster structures; calculating a statistical distribution of the formation of the potential cluster structures based on the relative energies of the possible conformations; calculating a collision cross section of the target analyte through quantum chemical analysis of the cluster structures determined from the statistical distribution; estimating the Kₒ value of at least one of the potential cluster structures based on the calculated cross section, wherein Kₒ is the reduced mobility constant; transmitting the estimated Kₒ values to the ion mobility spectrometer device; calculating the drift time for the potential cluster structures based on the estimated Kₒ values and the device properties and environmental factors; creating a detection algorithm based at least partially on the calculated drift time; and configuring the ion mobility spectrometer system based on the detection algorithm.

### BRIEF DESCRIPTION OF THE DRAWINGS

FIG. 1 shows the representative chemical structure of ammonia.

FIG. 2 depicts several of the lower energy, thermally favored ammonium (i.e. protonated ammonia)-water complexes for 1-6 water molecules.

FIG. 3 is a tabulation of cluster energetics for various ammonium-water complexes.

FIG. 4 shows the calculated enthalpy, ΔH, for various ammonium-water clusters.

FIG. 5 shows the calculated free energy, ΔG, for various ammonium-water clusters.

FIG. 6 shows the statistical distribution of various conformations of ammonium-water clusters.

FIG. 7 is a chart of literature values based on experimental data of proton affinities for various compounds compared to proton affinities calculated using three methods: MP2/MED (Uncorrected), MP2/MED (ZPE Corrected), and MP2G2MP2.

FIG. 8 is a chart of literature values based on experimental data of electron affinities of various compounds compared to calculated electron affinities.

FIG. 9 illustrates the calculation of the mobility constant (K) and collision cross-section (Ω_{D}) using a representative 12-4 Hard-Sphere Potential Model.

FIG. 10 shows the estimated values for a series of amine compounds compared to experimental values.

FIG. 11 is a library of Kₒ values for various possible clusters and conformations of ammonium-water clusters under a variety of environmental conditions.

FIG. 12 shows the three minimum energy conformations of mustard gas.

FIG. 13 illustrates the calculation of proton affinity for furan as a function of the protonation site.

FIG. 14 is a block diagram of a configuration computer system and an ion mobility spectrometer system.

### DETAILED DESCRIPTION

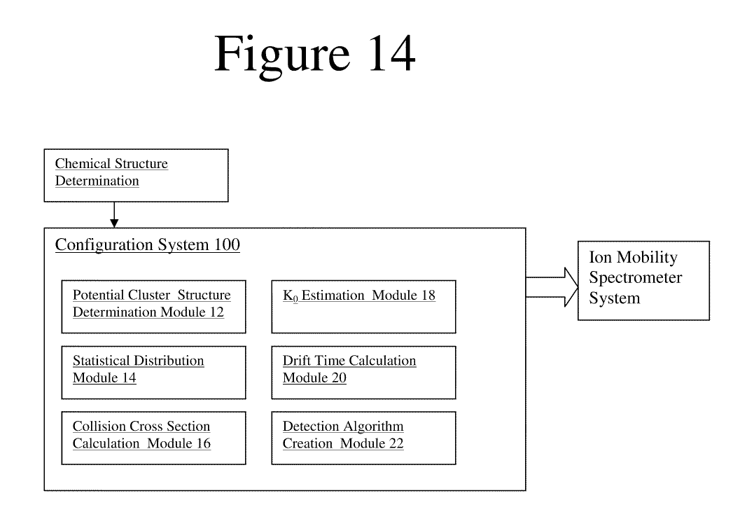

The invention relates to a method of configuring an ion mobility spectrometer system for detecting a target analyte. An ion mobility spectrometer system includes all ion mobility spectrometers known in the art including, for example, the APD 2000™, the ICAM™, the Multi-IMS™, and the RAID-M™. The method of this invention exhibits improved efficiency by allowing for the creation of a detection algorithm for use in an ion mobility spectrometer without the need for extensive experimental lab work. The implementation of this method is described below and in the examples. FIG. 14 illustrates configuration computer system 100 for carrying out the method.

A preliminary step involves identifying the target analyte. One or more chemical structures of the target analyte may be identified and mapped through conventional quantum chemical methods. Suitable analytes include any chemical compound or composition capable of being detected by an ion mobility spectrometer system, such as toxic industrial chemicals, narcotics, explosives, chemical agents, and hazardous materials. According to one embodiment of the invention, the target analyte is a toxic chemical. This can be accomplished through conventional means and input into configuration system 100 of FIG. 14 or can be accomplished by a module of configuration system 100.

After the target analyte is identified, an initial assessment can be made for determining whether a positive or negative ion mode is to be used in detecting the target analyte. Identification of the mode (or possibly both modes) dictates the reactive ions and the potential ion clusters that may be formed. This determination may involve analyzing the target analyte to determine whether the chemical structure of the target analyte more readily accepts protons or electrons, thus influencing the nature of cluster formation and how the cluster will behave in an electric field. If the molecule has a high proton affinity, which can be calculated or obtained from literature sources (if available), then a positive ion mode should typically be used. If the molecule has a high electron affinity, then a negative ion mode should typically be used. Both modes may be acceptable in certain circumstances.

Potential cluster structures for the analyte and the binding energies that correspond with the potential cluster structures can then be determined by potential cluster determination module 12. This may be accomplished using quantum chemical techniques and methods to analyze the chemical structures. As known in the art, quantum chemistry is a branch of theoretical chemistry that applies quantum mechanics in analyzing the electronic structure of atoms and molecules as pertaining to their physical properties and reactivity. In this invention, quantum chemical methods are employed to determine structures, tabulate and compare energetics of cluster structures or potential cluster structures, perform conformational searches, and ultimately determine what molecule takes the charge. In other aspects of this invention, other quantum chemical techniques and methods can be used to determine the size, shape, and mass of the clusters which are then used to determine the center of mass, the center of charge, and the other physical properties directly influencing cluster mobility. The quantum chemistry described in this invention can include some or all of the above-described analyses.

Determining the potential cluster structures using quantum chemistry typically involves interacting with a reagent. Water is a common reagent used in IMS and will tend to form cluster structures with the analyte. However, other reagents may be used to generate the reactive ion as well. Proposed reactions between the target analyte and the reagent(s) can be evaluated. For instance, if water is used as the reagent, different proposed reactions can be set up to determine how various numbers of water molecules interact, or cluster, with the analyte.

A statistical distribution of the formation of the potential cluster structures may be calculated, by statistical distribution module 14, based on the relative energies of the evaluated possible conformations. The probability of formation may be calculated using the relative energies of the various cluster structures as a function of relative humidity and temperature. This may be done by tabulating and/or comparing cluster energetics. For instance, relative energies may be calculated using Møller-Plesset second-order perturbation theory (MP2) and a moderate basis set (e.g., 6-311++G**) for each cluster using the GAMESS software suite (M. W. Schmidt, K. K. Baldridge, J. A. Boatz, S. T. Elbert, M. S. Gordon, J. H. Jensen, S. Koseki, N. Matsunaga, K. A. Nguyen, S. Su, T. L. Windus, M. Dupuis, & J. A. Montgomery, General Atomic and Molecular Electronic Structure System, J. Comput. Chem. 1993, 14, 1347-1363), herein incorporated by reference in its entirety. Other quantum chemistry programs such as Gaussian03, ACESII, and ACES III can also be used. Revision C.02 of Gaussian03 was developed by M. J. Frisch, G. W. Trucks, H. B. Schlegel, G. E. Scuseria, M. A. Robb, J. R. Cheeseman, J. A. Montgomery, Jr., T. Vreven, K. N. Kudin, J. C. Burant, J. M. Millam, S. S. Iyengar, J. Tomasi, V. Barone, B. Mennucci, M. Cossi, G. Scalmani, N. Rega, G. A. Petersson, H. Nakatsuji, M. Hada, M. Ehara, K. Toyota, R. Fukuda, J. Hasegawa, M. Ishida, T. Nakajima, Y. Honda, O. Kitao, H. Nakai, M. Klene, X. Li, J. E. Knox, H. P. Hratchian, J. B. Cross, V. Bakken, C. Adamo, J. Jaramillo, R. Gomperts, R. E. Stratmann, O. Yazyev, A. J. Austin, R. Cammi, C. Pomelli, J. W. Ochterski, P. Y. Ayala, K. Morokuma, G. A. Voth, P. Salvador, J. J. Dannenberg, V. G. Zakrzewski, S. Dapprich, A. D. Daniels, M. C. Strain, O. Farkas, D. K. Malick, A. D. Rabuck, K. Raghavachari, J. B. Foresman, J. V. Ortiz, Q. Cui, A. G. Baboul, S. Clifford, J. Cioslowski, B. B. Stefanov, G. Liu, A. Liashenko, P. Piskorz, I. Komaromi, R. L. Martin, D. J. Fox, T. Keith, M. A. Al-Laham, C. Y. Peng, A. Nanayakkara, M. Challacombe, P. M. W. Gill, B. Johnson, W. Chen, M. W. Wong, C. Gonzalez, & J. A. Pople, Gaussian, Inc., Wallingford Conn. (2004). ACES II and ACES III are program products of the Quantum Theory Project, University of Florida, and was developed by J. F. Stanton, J. Gauss, J. D. Watts, M. Nooijen, N. Oliphant, S. A. Perera, P. G. Szalay, W. J. Lauderdale, S. A. Kucharski, S. R. Gwaltney, S. Beck, A. Balková D. E. Bernholdt, K. K. Baeck, P. Rozyczko, H. Sekino, C. Hober, and R. J. Bartlett. Integral packages included are VMOL (J. Almlöf and P. R. Taylor); VPROPS (P. Taylor) ABACUS; (T. Helgaker, H. J. Aa. Jensen, P. Jørgensen, J. Olsen, and P. R. Taylor); and the GAMESS integral package.

When analyzing the statistical distribution, conformations with smaller percentages can be ignored simply because of the unlikely possibility that the molecule will exist under those conditions long enough to be detected. Additionally, electronic noise associated with the IMS instrument will, in many cases, overwhelm very small peaks; i.e., smaller peaks will likely be lost in the noise or otherwise dominated by the more prominent peaks. Thus, the smaller the percentage gets, the harder generally it is to detect in the IMS signal.

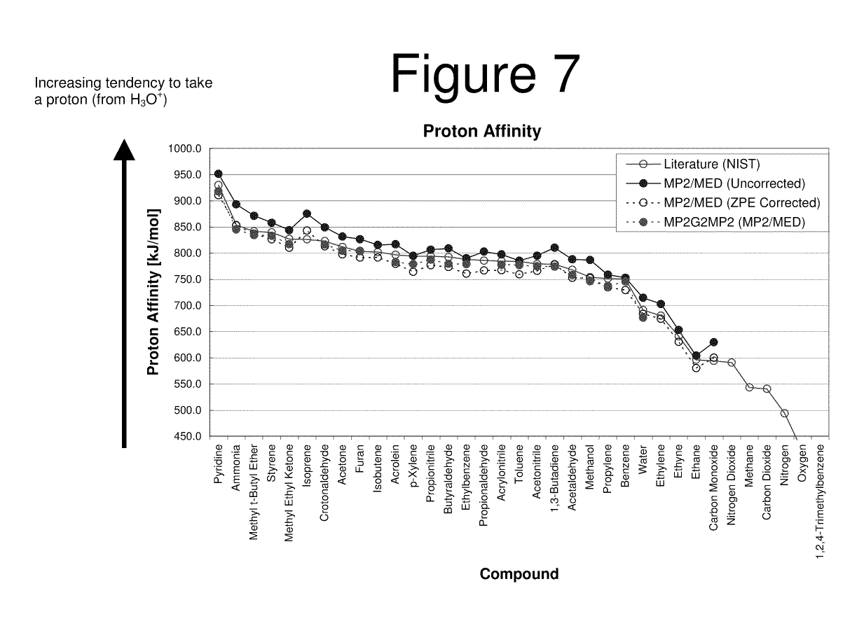

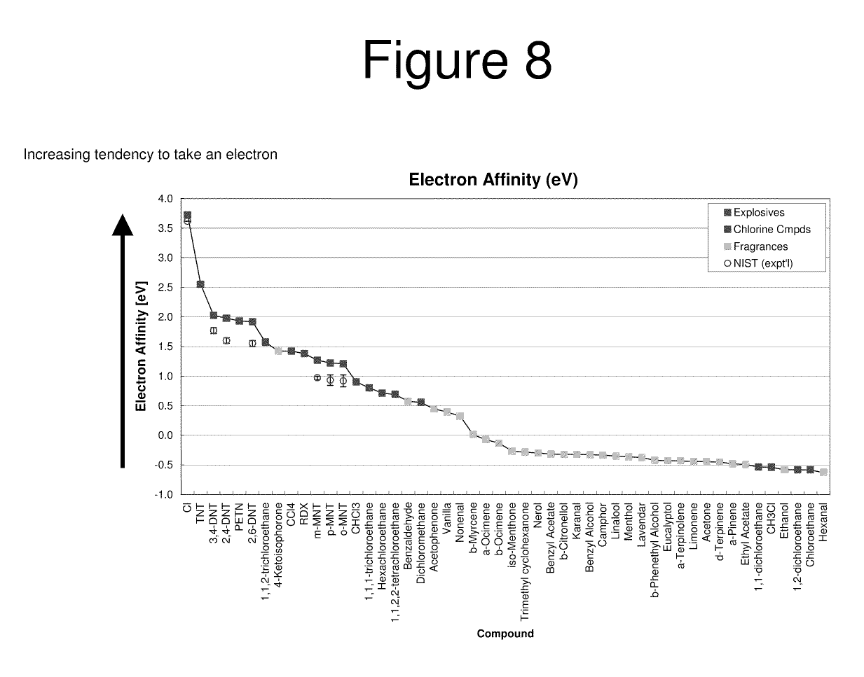

That the ion cluster forms at all can also be determined. This may be done in parallel with the calculation of the statistical distribution of the formation of the potential cluster structures, described above, for instance by using the relative Gibbs free energies (ΔG) in a Boltzmann statistical distribution analysis. One way to determine the probability that the ion cluster exists is to calculate the molecule's proton affinity; another way is to calculate the electron affinity. Once calculated, the proton affinity or electron affinity may be compared with literature values (if they exist) to evaluate accuracy. FIG. 7 shows the literature values (based on experimental data) of proton affinities for various compounds compared to proton affinities calculated using three methods. FIG. 7 is relevant to positive mode IMS, which looks for compounds that have the greatest tendency of taking on a proton (the positive charge carrier). FIG. 8 shows the electron affinity of various compounds and is relevant to negative mode IMS, which looks for compounds that have the greatest tendency of taking on an electron (the negative charge carrier). Various calculations may be used to further refine the proton affinity or electron affinity values. For instance, the zero-point energy (ZPE) correction takes into account the internal vibrational energy of the molecule, and generally leads to calculated values that are more consistent with the experimental values found in the literature. The MP2G2MP2 methodology, a modified G2(MP2) protocol based on an internal program, can further be used to minimize the unsigned error of the prediction. The MP2G2MP2 methodology is a modified G2(MP2) protocol in which, among other modifications, an MP2 structure is used in place of the HF structure in the standard G2(MP2) protocol, as described in L. A. Curtiss, K. Raghavachari, & J. A. Pople, GAUSSIAN-2 Theory Using Reduced Møller-Plesset Orders, J. Chem. Phys. 1993, 98 1293, herein incorporated by reference in its entirety.

Clusters may be analyzed according to their thermodynamic properties to determine whether each of the clusters will take a charge. Thermodynamic properties, including enthalpy (H) and Gibbs free energy (G) for the cluster formation reactions are analyzed to determine if they are negative values. If the ΔG(G_{products}−G_{reactants}) is negative, the modeled process is thermodynamically allowed, and the proposed process can occur. Analyzing whether each process can occur, as a function of temperature, reveals which potential clusters can be formed.

The collision cross section of the target analyte can then be calculated, by collision cross section calculation module 16, through quantum chemical analysis of the cluster structures determined from the statistical distribution. Ω_{D}, discussed below in the Kₒ formula, is the effective collision cross section of the ion. An interaction model potential can be used to describe the strength of an inter-molecular interaction (the attractive or repulsive forces) as a function of the distance over which it occurs. The selected model potential utilizes the minima energy conformation and takes into account both the center of mass and the charge for the target clusters.

Next, the Kₒ value of at least one of the potential cluster structures is estimated, by estimation module 18, based on the calculated cross section, wherein Kₒ is the reduced mobility constant. The 12-4 hard-sphere potential model, as described in G. A. Eiceman & Z. Karpas, Ion Mobility Spectroscopy (CRC Press 2005), herein incorporated by reference in its entirety, may be used for predicting Kₒ in simple systems. However, in more complex cases, other potential models known in the art may be preferred. Existing potentials may be tuned or new potential forms may also be developed to predict Kₒ. Potentials will be applicable to classes of compounds and will be selected based on performance against experimental data for known systems. This will provide confidence when extrapolating the procedure to compounds with unknown mobility constants within a class.

Once a model is chosen the physical parameters upon which it depends (for example, the center of mass, the center of charge, the molecular volume, etc.) are calculated through quantum chemical techniques. The center of mass, R, of a system of particles is defined as the average of their positions, rᵢ, weighted by their masses, mᵢ, with R=Σmᵢrᵢ/Σmᵢ. The input is (x, y, z, mass) for each atom of the atoms in the previously obtained structure. The output is (x, y, z) for the center of mass. To assist in these calculations, any suitable program that properly combines the relevant values may be used. For instance, a simple Fortran code may be used.

The center of charge (positive or negative) has a similar calculation to the center of mass, Q=Σqᵢrᵢ/Σqᵢ, except that it is based on partial charges. The input is (x, y, z, partial charge) for each atom of the atoms in the previously obtained structure, and the output is (x, y, z) for the center of charge.

The center of mass coordinates of the drift tube medium (e.g., air, CO₂, N₂, O₂, argon) and the static polarizability of the medium, up are also factored into the equation. “Polarizability” is the relative tendency of a charge distribution, like the electron cloud of an atom or molecule, to be distorted from its normal shape by an external electric field, which may be caused, for example, by the presence of a nearby ion.

The reduced mobility constant (Kₒ) may then be calculated for a class of compounds using the calculated collision cross section and the equation: Kₒ=(3e/16N)(2π/mkT_{eff})^{1/2}[1/Ω_{D}(T_{eff})](273/T)(P/760), with the variables represented as:
e=Charge on an electron=1.60217646×10⁻¹⁹ coulombs
π=3.1415926535898
N=Number density of neutral-gas molecules at the pressure of the measurement=6.02214179×10²³ molecules/mol. N_{act}=N*P/(760.0*R*T_{eff})
P=Pressure (torr)
μ=Reduced mass of ion and gas of the supporting atmosphere=m₁m₂/(m₁+m₂)
k=Boltzmann constant=1.3806503×10⁻²³ m² kg sec⁻² K⁻¹
T_{eff}=effective temperature (Kelvin) of the ion determined by the thermal energy and the energy acquired in the electric field
Ω_{D}=effective collision cross section of the ion in the supporting atmosphere

This procedure can be used to tune a class of compounds. As such, a series of model compounds for which experimental data exists can be used in evaluating the model. If the calculated mobility constant is too far from the literature value, then the potential model can be tuned, a different potential model can be used, or a new model may be developed. The quality of the implemented potential model is assessed based on the use of, and application to, model compounds for which experimental data exists.

Next, the estimated Kₒ values are transmitted, electronically or otherwise, to the ion mobility spectrometer system. The ion mobility spectrometer system may then be configured based on the device properties and the environmental factors. Device properties include, for instance, the make and model number of the ion mobility spectrometer, the drift gas, the temperature of the drift tube, and the length and diameter of the drift tube. Environmental factors include, for instance, the temperature, pressure, and the relative humidity at which the ion mobility spectrometer is operated.

The drift time (t_{d}) may then be calculated, by drift time calculation module 20, for the potential cluster structures based on the estimated Kₒ values, the device properties (drift gas, temperature of the drift tube, length and diameter of the drift tube), and the environmental factors (relative humidity, pressure) using the following equation:

t_{d}=d/v_{D}, with v_{D}=K₀(T_{drift tube}/273)(760/Pₐₜₘ)E
d=drift tube length (cm)
v_{D}=drift velocity (cm/s)
E=electric field
T=temperature (Kelvin)
P=pressure (torr)
K=K₀(T/273)(760/P)

A detection algorithm can be created, by detection algorithm creation module 22, based at least partially on the calculated drift time. In one embodiment, the detection algorithm is based on the calculated drift time and/or combinations of drift times obtained under different operating conditions. The operating conditions include, for instance, ion mode, drift tube temperature, and concentration. The ion mobility spectrometer system may then be configured based on the detection algorithm. Specifically, settings on the ion mobility spectrometer are adjusted to provide the desired operation and detection. In one embodiment of the claimed invention, the ion mobility spectrometer system may be configured based on an input calculated drift time of the potential cluster structures.

Using this model, the instrument settings can be altered to get a contrast in peaks between interfering compounds. In other words, the settings can be modified to create peaks of preferred height and width, making for easier detection of the analyte. Advantageously, this allows for humidity and other environmental factors to be taken into account, which will otherwise cause the window of the IMS to shift away from the information sought.

This system offers a number of advantages over the conventional systems currently in use. First, it creates a much more efficient way of configuring an IMS system with the necessary data to detect a new threat, i.e. an analyte that has not yet been analyzed experimentally. By using the quantum chemical techniques described in this invention, a detection algorithm suitable for use in an IMS system can be created in a matter of days to weeks to months, whereas the conventional system that relies purely on experimental results will take several months. This can be critical, especially in circumstances when the target analyte represents a significant threat to national security and configuring the IMS to account for the new analyte as quickly as possible is paramount.

Second, the detection algorithm that is created through this method allows for the operator of the IMS to take into account various interfering compounds. Often times, the interfering compounds produce peaks similar to those of the target analyte, causing the operator to see false positive and well as false negative results. With the detection algorithm taking into account various conditions, such as humidity and other environmental factors, the detection window can be altered to get a contrast in peaks between interfering compounds. The modified settings thus create additional separation in the peaks, making for easier and more accurate detection of the analyte.

### EXAMPLES

Example 1 describes the implementation of the method to ammonia. Example 2 describes the implementation of Example 1.3 in the ammonia example to mustard gas. Example 3 describes the implementation of Example 1.5 in the ammonia example to furan.

### Example 1

### Implementation of the Method to Ammonia

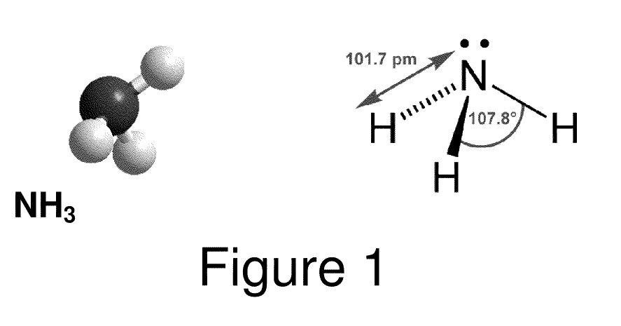

1.1 Identify Structure of New Threat: First, the structure of the ammonia molecule was identified and mapped through conventional quantum chemistry methods. FIG. 1 shows the representative minimum energy chemical structure of ammonia.

1.2 Determine Whether Positive and/or Negative Ion Mode: Next, the ammonia molecule was analyzed to determine its partial charges and dipole moments, which will influence how it will behave in an electric field. If the molecule has a high proton affinity, which can be calculated or obtained from literature sources (if available), then a positive ion mode should typically be used. If the molecule has a high electron affinity, then a negative ion mode should typically be used. In this case, ammonia has a high proton affinity of 854 kJ/mol, so a positive ion mode was used.

1.3 Choose Structures: Since ammonia is a relatively simple structure, only a single minimum energy conformation was obtained at the MP2//6-311++G** level of chemical theory. See Example 2 for mustard gas, a more complex structure, which has at least three minimum energy conformations.

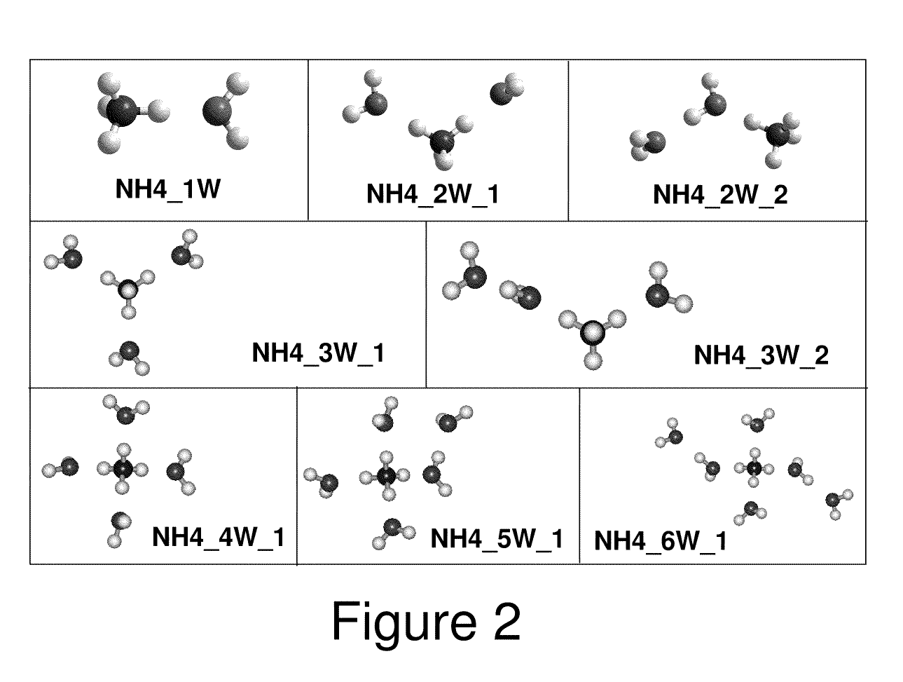

1.4 Determining Potential Cluster Structures: FIG. 2 depicts several of the lower energy thermally favored ammonium (i.e., the protonated ammonia)-water complexes for 1-6 water molecules. Water is a primary molecule that the analyte will form clusters with when exposed to the atmosphere. In FIG. 2, certain cluster conformations with higher energy levels have been omitted. These figures show how the various number of water molecules will interact with the analyte. Water will often form dimers, and a water dimer interacting with ammonium will shift the center of mass relative to that of two water monomers interacting with ammonium. For instance, in the case of the two-water and the three-water complexes, the existence of dimers shifts the center of mass, while in the figures showing no dimers, the center of mass is more central to the cluster. These variables can also shift the center of charge. Each conformation has a unique center of mass and center of charge.

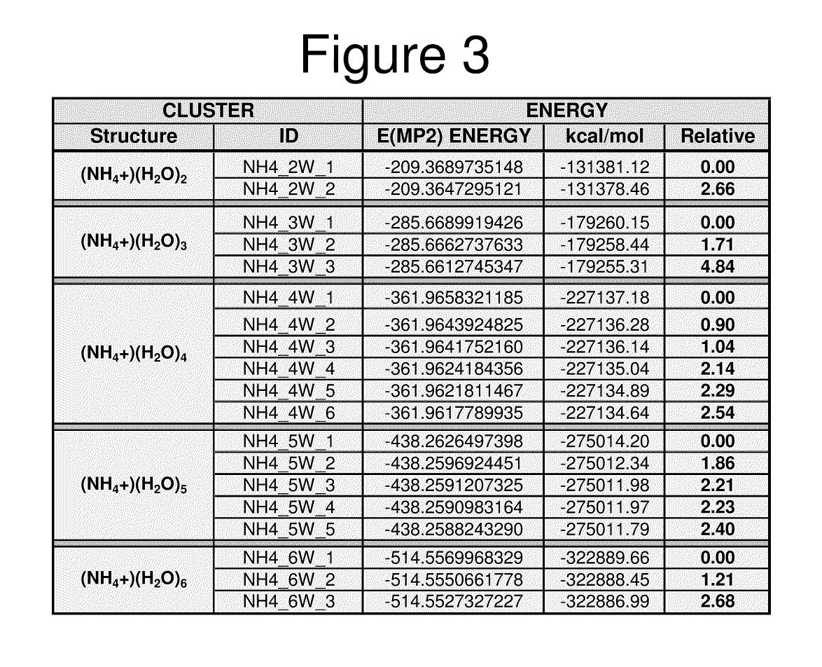

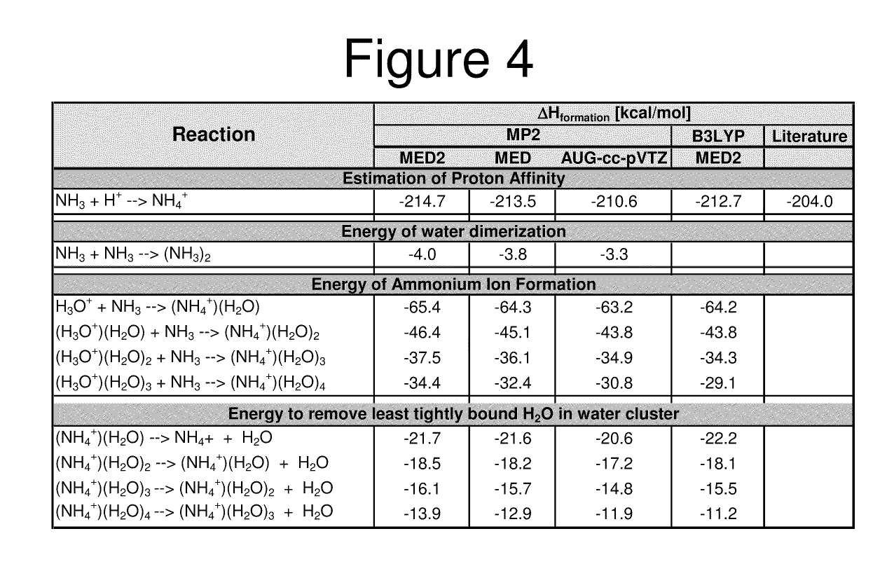

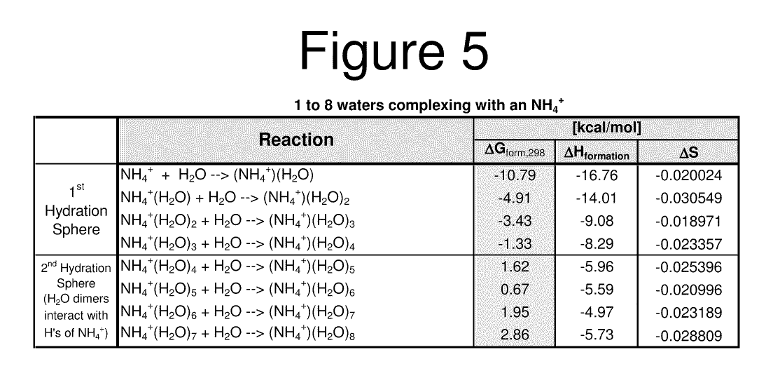

1.5 Tabulating/Comparing Cluster Energetics: Relative energies were calculated using Møller-Plesset second-order perturbation theory and a moderate basis set (6-311++G**) for each cluster using the GAMESS™ software suite. Other quantum chemistry programs such as Gaussian03™ and ACES™ can also be used. FIG. 3 is an example of this tabulation for various ammonium-water clusters. In this example, the reagent was assumed to be water which forms hydronium, the reactive ion. The thermodynamic properties, including enthalpy (ΔH) and free energy (ΔG), were analyzed to determine if they were “large” negative values for formation of various clusters. FIG. 4 shows the ΔH for various ammonium-water clusters. As shown in FIG. 4, for each instance, the large negative enthalpies were consistent with the hydronium-water clusters transferring a proton to ammonia to form the ammonium ion. The thermodynamic data for the formation of ammonia-ammonium complexes (large negative ΔH) illustrates that this reaction can happen. It is likely that this chemistry will be enhanced at higher ammonia concentrations. FIG. 5 shows the ΔG for various ammonium-water clusters. If the ΔG is negative, the modeled process is thermodynamically allowed. ΔGs were computed to verify that the reaction has a negative Gibbs Free Energy. Ammonia presents a fairly straightforward analysis of what is going to take the charge. See Example 3 for a more complex calculation involving furan in which there are multiple possibilities for how to protonate the structure, with some possibilities more energetically favorable than others.

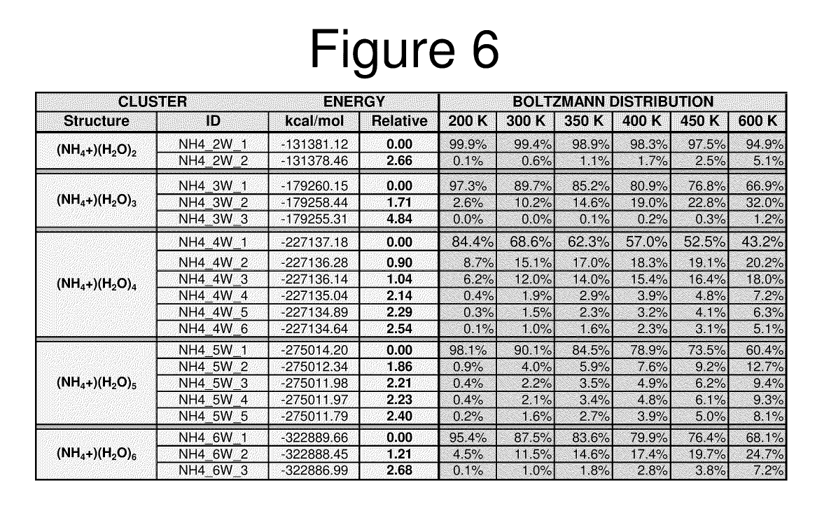

1.6 Determining Probability that the Conformation Exists: The probability that a particular conformation was present at a specified temperature was calculated using the relative free energies (ΔG) in a Boltzmann statistical distribution analysis. FIG. 6 shows the statistical distribution of various conformations of ammonium-water clusters. Conformations with smaller percentages were ignored simply because of the unlikely possibility that the molecule will exist under those conditions.

1.7 Comparing the Proton Affinity with Literature Values: FIG. 7 shows the literature values (based on experimental data) of proton affinities for various compounds, including ammonia, compared to proton affinities calculated using three methods. The zero-point energy (ZPE) correction was used to take into account the internal vibrational energy of the molecule, which leads to calculated values that are more consistent with the experimental values found in the literature. The MP2G2MP2 methodology was used to further minimize the unsigned error of the prediction. As can be seen in FIG. 7, the calculated proton affinity, run in accordance with this example, is close to the literature value, especially when ZPE corrected or when using the MP2G2MP2 protocol. FIG. 8 shows the electron affinity of various compounds. FIG. 8 is based on negative mode IMS, which looks for compounds that have the greatest tendency to take on an electron (a negative charge).

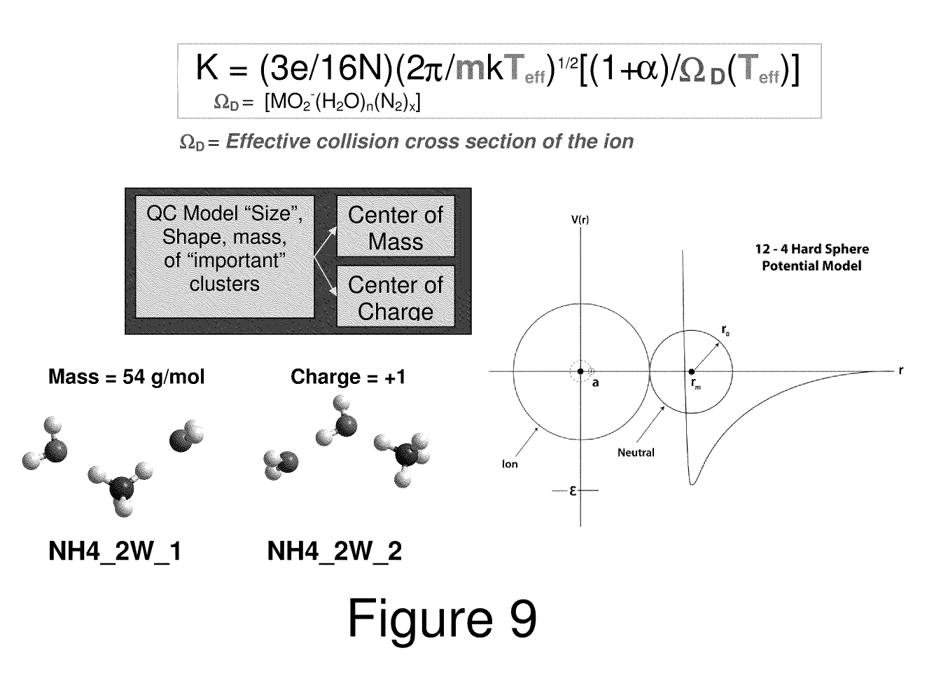

1.8 Calculate the Collision Cross Section: FIG. 9 illustrates the calculation of the effective collision cross section, Ω_{D}, of the ion. A model potential is used to define the interaction (the strength of the interaction forces as a function of distance and spatial orientation) between chemical entities. The developed model potential utilizes the minima energy conformation and takes into account, among other physical parameters, the center of mass and the charge for the target clusters. For each of the minimum energy ammonia clusters, the centers of mass and charge are different. In this case, although the two identified ammonia clusters having two water molecules have the same mass and total charge, they will each behave differently in the IMS due to differences in the centers of mass and charge distribution within each unique species.

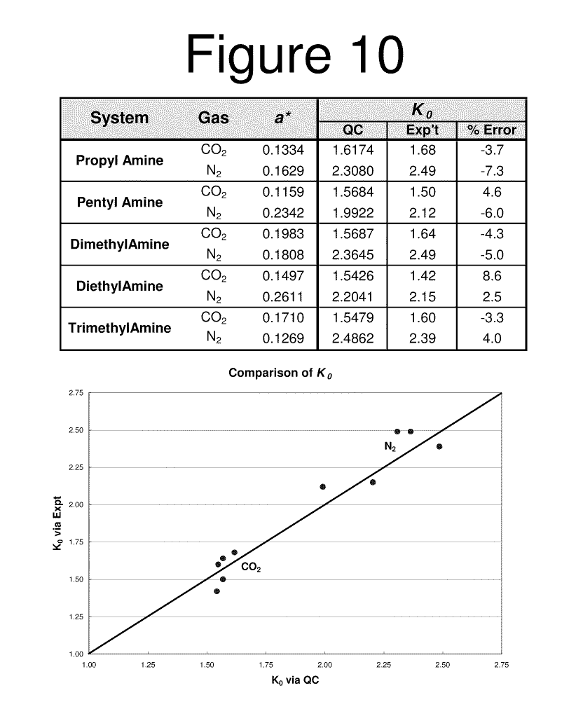

1.9 Estimate the Reduced Mobility Constant (Kₒ): Ammonium is a comparatively small ion having a fast reduced mobility, previously reported as 2.8 cm²/V-s at 150° C. with water-based ionization chemistry. Therefore, the 12-4 hard sphere potential model was used for modeling a series of amine analytes in two different carrier gases and was sufficient in predicting Kₒ for these systems, as can be seen in FIG. 10.

The center of mass and center of charge were calculated in order to determine the collision cross section which leads to the mobility constant and ultimately to the drift time. The center of mass, R, of a system of particles is defined as the average of their positions, rᵢ, weighted by their masses, mᵢ, with R=Σmᵢrᵢ/Σmᵢ. The input is (x, y, z, mass) for each atom of the atoms in the quantum chemistry minimum energy structure, and the output is (x, y, z) for the center of mass. The center of charge (positive or negative) has a similar calculation to the center of mass, Q=Σqᵢrᵢ/Σqᵢ, except that it is based on quantum chemistry generated partial charges. The input is (x, y, z, partial charge) for each atom of the atoms in the structure, and the output is (x, y, z) for the center of charge. A standard Fortran routine was used to sum the values for the center of mass and center of charge. The center of mass coordinates of the drift tube medium (e.g., air, CO₂, N₂, O₂, argon) and the static polarizability of the medium, α_{P} were also factored into the equation.

The reduced mobility constant (Kₒ) was then calculated using the collision cross section and the equation: Kₒ=(3e/16N)(2π/mkT_{eff})^{1/2}[1/Ω_{D}(T_{eff})](273/T)(P/760), with the variables represented as:
e=Charge on an electron=1.60217646×10⁻¹⁹ coulombs
π=3.1415926535898
N=Number density of neutral-gas molecules at the pressure of the measurement=6.02214179×10²³ molecules/mol. N_{act}=N*P/(760.0*R*T_{eff})
P=Pressure (torr)
μ=Reduced mass of ion and gas of the supporting atmosphere=m₁m₂/(m₁+m₂)
k=Boltzmann constant=1.3806503×10⁻²³ m²kg sec⁻² K⁻¹
T_{eff}=effective temperature (Kelvin) of the ion determined by the thermal energy and the energy acquired in the electric field
Ω_{D}=effective collision cross section of the ion in the supporting atmosphere

If the calculated mobility constant is too far from the literature value for the selected model compounds, a different potential model should be used, or a new model may be created. As can be seen in FIG. 10, the estimated values for a series of amine compounds compared well with the literature values. Therefore, the 12-4 hard sphere potential model was sufficient for this class of compounds.

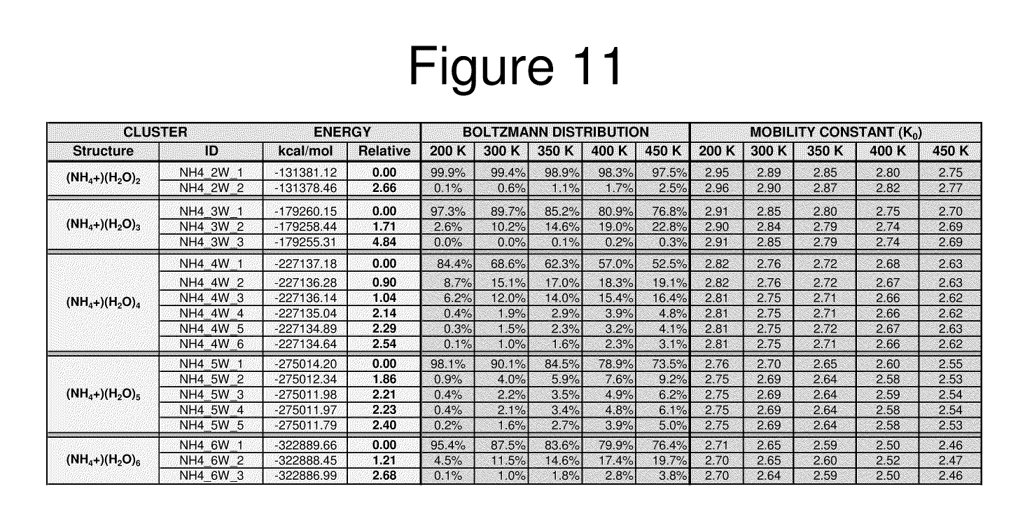

1.10 Build a Library of Kₒ for Possible Cluster Structures: After each Kₒ was calculated for the various possible clusters and conformations under a variety of environmental conditions (e.g., temperature), a library of values was created. FIG. 11 illustrates this library of values. The data was translated into a relative peak height (based on the Boltzmann statistical distribution) and width for analysis in an IMS.

1.11 Calculate drift time: The drift time for all relevant clusters based on Kₒ and the environmental properties (relative humidity, pressure) and instrument properties (drift gas, temperature of the drift tube, length of the drift tube) was calculated using the following equation:

t_{d}=d/v_{D}, with v_{D}=Kₒ(T_{drift tube}/273)(760/Pₐₜₘ)E
d=drift tube length (cm)
v_{D}=drift velocity (cm/s)
E=electric field
T=temperature (Kelvin)
P=pressure (torr)
K=Kₒ(T/273)(760/P)

### Example 2

### Determining Minimum Energy Conformations of Mustard Gas

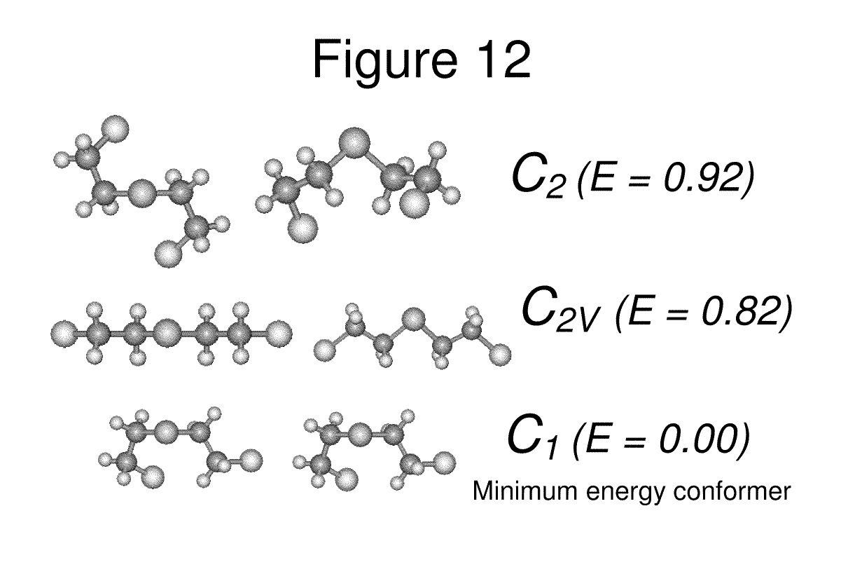

FIG. 12 shows the three minimum energy conformations of sulfur mustard gas. In this case, C₁ is the dominant conformation because the energy of the structure is the lowest (E=0.00) relative to the other conformations (C_{2V} and C₂). The minimum energy was calculated using the GAMESS™ software.

### Example 3

### Tabulating/Comparing Cluster Energetics of Furan

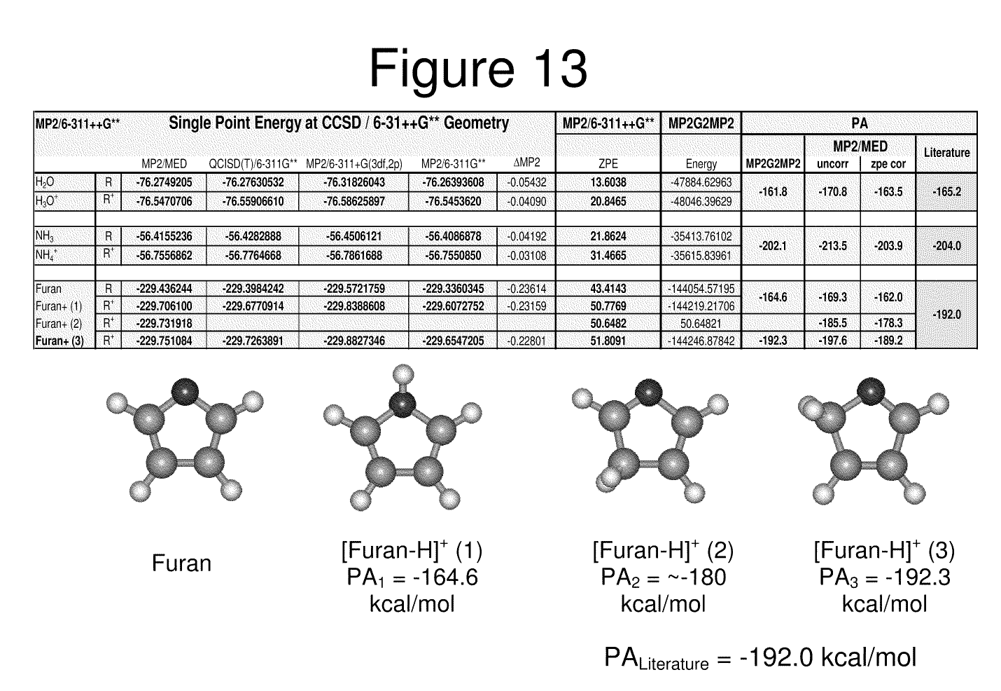

Furan involves a more complex calculation in determining relative energies. FIG. 13 illustrates the determination of where furan will take the proton charge. Although there are multiple possibilities for how to protonate the structure, some possibilities are more energetically favorable than others. In this case, [Furan-H]⁺ (3) was shown to provide the most energetically favorable protonated structure. The third structure, where the proton was placed on the carbon atom adjacent to the oxygen atom, was preferable to both the first structure (proton placed on the oxygen) and the second structure (proton placed on the carbon in the β-position relative to the oxygen). This was confirmed by comparing the proton affinity value provided by the literature to the proton affinity value of each potential structure.

The invention can be accomplished by a computing device, or multiple computing devices programmed with computer readable software instructions to cause the devices to accomplish the desired functions. The devices include memory including computer readable media on which the software is recorded. The invention has been described through functional modules, which are defined by executable instructions recorded on computer readable media which cause a computer to perform method steps when executed. The modules have been segregated by function for the sake of clarity. However, it should be understood that the modules need not correspond to discrete blocks of code and the described functions can be carried out by the execution of various code portions stored on various media and executed at various times.

What is claimed is:

1. A method of configuring an ion mobility spectrometer system for detecting a target analyte, the method comprising:
determining potential cluster structures for the target analyte, and the binding energies that correspond with formation of the potential cluster structures;
calculating a statistical distribution of the formation of the potential cluster structures based on the relative energies of the possible conformations;
calculating a collision cross section of the target analyte through quantum chemical analysis of the cluster structures determined from the statistical distribution;
estimating the Kₒ value of at least one of the potential cluster structures based on the calculated cross section, wherein Kₒ is the reduced mobility constant;
transmitting the estimated Kₒ values to the ion mobility spectrometer device;
calculating the drift time for the potential cluster structures based on the estimated Kₒ values and the device properties and environmental factors;
creating a detection algorithm based at least partially on the calculated drift time; and
configuring the ion mobility spectrometer system based on the detection algorithm.

2. The method of claim 1, further comprising determining one or more chemical structures of the target analyte.

3. The method of claim 1, further comprising configuring the device based on the device properties and the environmental factors.

4. The method of claim 1, wherein the target analyte is a toxic chemical.

5. The method of claim 1, wherein the step of determining potential cluster structures involves analyzing the chemical structures using quantum chemistry.

6. The method of claim 1, wherein the step of determining potential cluster structures further involves determining the thermodynamics that correspond with formation of the potential cluster structures.

7. The method of claim 6, wherein the determination of the thermodynamics involves calculating the Gibbs free energy (ΔG) and/or enthalpy (ΔH).

8. The method of claim 6, wherein the step of calculating a statistical distribution calculates the probability of formation using the differences in the Gibbs free energy (ΔG) of the cluster structures as a function of relative humidity and temperature.

9. The method of claim 1, wherein the step of calculating the collision cross section involves determining the size, shape, and mass of the potential clusters using quantum chemistry.

10. The method of claim 9, wherein the step of calculating the collision cross section further involves the use of a model potential.

11. The method of claim 10, wherein the model potential determines how two entities interact.

12. The method of claim 1, wherein the device properties include the make and model number of the ion mobility spectrometer, the drift gas, the temperature of the drift tube, and the length of the drift tube.

13. The method of claim 1, wherein the environmental factors include the temperature, pressure, and the relative humidity at which the ion mobility spectrometer is measured.

14. The method of claim 1, further comprising, before the step of determining potential cluster structures, the step of determining whether a positive and/or negative ion mode is to be used in detecting the target analyte.

15. The method of claim 14, wherein the step of determining a positive and/or negative ion mode involves analyzing the target analyte to determine whether the chemical structure of the target analyte has high proton affinity or has high electron affinity.

16. The method of claim 1, further comprising the step of inputting the calculated drift time of the potential cluster structures into the ion mobility spectrometer device to configure the device.

17. The method of claim 1, wherein the step of creating a detection algorithm is based on the calculated drift time and/or combinations of drift times obtained under different operating conditions.

18. The method of claim 17, wherein the operating conditions are selected from the group consisting of ion mode, and concentration.

19. An apparatus for configuring an ion mobility spectrometer system for detecting a target analyte, the apparatus comprising:
means for determining potential cluster structures for the analyte, and the binding energies that correspond with formation of the potential cluster structures;
means for calculating a statistical distribution of the formation of the potential cluster structures based on the relative energies of the possible conformations;
means for calculating a collision cross section of the target analyte through quantum chemical analysis of the cluster structures determined from the statistical distribution;
means for estimating the Kₒ value of at least one of the potential cluster structures based on the calculated cross section, wherein Kₒ is the reduced mobility constant;
means for transmitting the estimated Kₒ values to the ion mobility spectrometer device;
means for calculating the drift time for the potential cluster structures based on the estimated Kₒ values and the device properties and environmental factors;
means for creating a detection algorithm based at least partially on the calculated drift time; and
means for configuring the ion mobility spectrometer system based on the detection algorithm.

20. The method of claim 19, further comprising determining one or more chemical structures of the target analyte.

21. The method of claim 19, further comprising configuring the device based on the device properties and the environmental factors.

22. The apparatus of claim 19, wherein the target analyte is a toxic chemical.

23. The apparatus of claim 19, wherein the means for determining potential cluster structures further comprises means for analyzing the chemical structures using quantum chemistry.

24. The apparatus of claim 19, wherein the means for determining potential cluster structures further comprises means for determining the thermodynamics that correspond with formation of the potential cluster structures.

25. The apparatus of claim 24, wherein the means for determining the thermodynamics further comprises means for calculating the Gibbs free energy (ΔG) and/or enthalpy (ΔH).

26. The apparatus of claim 24, wherein the means for calculating a statistical distribution further comprises means for calculating the probability of formation using the differences in the Gibbs free energy (ΔG) of the cluster structures as a function of relative humidity and temperature.

27. The apparatus of claim 19, wherein the means for calculating the collision cross section further comprises means for determining the size, shape, charge distribution, and mass of the potential clusters using quantum chemistry.

28. The apparatus of claim 27, wherein the means for calculating the collision cross section further comprises means for using a model potential.

29. The apparatus of claim 28, wherein the means for using a model potential further comprises means for determining how two entities interact.

30. The apparatus of claim 19, wherein the device properties include the make and model number of the ion mobility spectrometer, the drift gas, the temperature of the drift tube, and the length and diameter of the drift tube.

31. The apparatus of claim 19, wherein the environmental factors include the temperature, pressure, and the relative humidity at which the ion mobility spectrometer is measured.

32. The apparatus of claim 19, further comprising means for determining whether a positive and/or negative ion mode is to be used in detecting the target analyte.

33. The apparatus of claim 32, wherein the means for determining a positive and/or negative ion mode further comprises means for analyzing the target analyte to determine whether the chemical structure of the target analyte has high proton affinity or has high electron affinity.

34. The apparatus of claim 19, further comprising means for inputting the calculated drift time of the potential cluster structures into the ion mobility spectrometer device to configure the device.

35. The apparatus of claim 19, wherein the means for creating a detection algorithm is based on the calculated drift time and/or combinations of drift times obtained under different operating conditions.

36. The apparatus of claim 35, wherein the operating conditions are selected from the group consisting of ion mode, and concentration.

37. A computer program product, comprising a computer usable medium having a computer readable program code adapted to be executed to implement a method of configuring an ion mobility spectrometer system for detecting a target analyte, said method comprising:
determining, by a potential cluster determination module, potential cluster structures for the analyte, and the binding energies that correspond with formation of the potential cluster structures;
calculating, by a statistical distribution module, a statistical distribution of the formation of the potential cluster structures based on the relative energies of the possible conformations;
calculating, by a collision cross section calculation module, a collision cross section of the target analyte through quantum chemical analysis of the cluster structures determined from the statistical distribution;
estimating, by an estimation module, the Kₒ value of at least one of the potential cluster structures based on the calculated cross section, wherein Kₒ is the reduced mobility constant;
transmitting the estimated Kₒ values to the ion mobility spectrometer device;
calculating, by a drift time calculation module, the drift time for the potential cluster structures based on the estimated Kₒ values and the device properties and environmental factors;
creating, by a detection algorithm creation module, a detection algorithm based at least partially on the calculated drift time; and
configuring the ion mobility spectrometer system based on the detection algorithm.

38. The method of claim 37, further comprising determining one or more chemical structures of the target analyte.

39. The method of claim 37, further comprising configuring the device based on the device properties and the environmental factors.

40. The computer program product of claim 37, wherein the target analyte is a toxic chemical.

41. The computer program product of claim 37, wherein the step of determining potential cluster structures involves analyzing the chemical structures using quantum chemistry.

42. The computer program product of claim 37, wherein the step of determining potential cluster structures further involves determining the thermodynamics that correspond with formation of the potential cluster structures.

43. The computer program product of claim 42, wherein the determination of the thermodynamics involves calculating the Gibbs free energy (ΔG) and/or enthalpy (ΔH).

44. The computer program product of claim 42, wherein the step of calculating a statistical distribution calculates the probability of formation using the differences in the Gibbs free energy (ΔG) of the cluster structures as a function of relative humidity and temperature.

45. The computer program product of claim 37, wherein the step of calculating the collision cross section involves determining the size, shape, and mass of the potential clusters using quantum chemistry.

46. The computer program product of claim 45, wherein the step of calculating the collision cross section further involves the use of a model potential.

47. The computer program product of claim 46, wherein the model potential determines how two entities interact.

48. The computer program product of claim 37, wherein the device properties include the make and model number of the ion mobility spectrometer, the drift gas, the temperature of the drift tube, and the length and diameter of the drift tube.

49. The computer program product of claim 37, wherein the environmental factors include the temperature, pressure, and the relative humidity at which the ion mobility spectrometer is measured.

50. The computer program product of claim 37, further comprising, before the step of determining potential cluster structures, the step of determining whether a positive and/or negative ion mode is to be used in detecting the target analyte.

51. The computer program product of claim 50, wherein the step of determining a positive and/or negative ion mode involves analyzing the target analyte to determine whether the chemical structure of the target analyte has high proton affinity or has high electron affinity.

52. The computer program product of claim 37, further comprising the step of inputting the calculated drift time of the potential cluster structures into the ion mobility spectrometer device to configure the device.

53. The computer program product of claim 37, wherein the step of creating a detection algorithm is based on the calculated drift time and/or combinations of drift times obtained under different operating conditions.

54. The computer program product of claim 53, wherein the operating conditions are selected from the group consisting of ion mode, and concentration.
